(19) United States
(12) Patent Application Publication
(10) Pub. No.: US 2023/0419401 A1
(43) Pub. Date: Dec. 28, 2023

(54) METHODS AND SYSTEMS FOR LOAN RISK ASSESSMENT IN A SMART CITY BASED ON THE INTERNET OF THINGS

(71) Applicant: CHENGDU QINCHUAN IOT TECHNOLOGY CO., LTD., Chengdu, Sichuan (CN)

(72) Inventors: Zehua SHAO, Chengdu (CN); Yong LI, Chengdu (CN); Bin LIU, Chengdu (CN); Yaqiang QUAN, Chengdu (CN); Yongzeng LIANG, Chengdu (CN)

(73) Assignee: CHENGDU QINCHUAN IOT TECHNOLOGY CO., LTD., Chengdu, Sichuan (CN)

(21) Appl. No.: 17/813,595

(22) Filed: Jul. 19, 2022

(30) Foreign Application Priority Data
Jun. 28, 2022 (CN) 202210741577.2

(51) Int. Cl. G06Q 40/02

(52) U.S. Cl. CPC G06Q 40/025

(57) ABSTRACT

The present disclosure provides a method for loan risk assessment in a smart city based on an Internet of Things. The method includes obtaining a risk query request generated in response to a loan request from a financial service platform; determining a related person of the loan object, an income and expenditure situation of which is similar to that of the loan object; in response to the risk query request, determining basic information of the loan object based on a population information platform, which at least includes income and expenditure information; obtaining a first loan information of the loan object and a second loan information of the related person based on the financial service platform; determining a loan risk of the loan object based on the basic information, the first loan information, and the second loan information; and sending the loan risk to the financial service platform.

### CROSS-REFERENCE TO RELATED APPLICATIONS

This application claims priority to Chinese Patent Application No. 202210741577.2, filed on Jun. 28, 2022, the entire contents of which are hereby incorporated by reference.

### TECHNICAL FIELD

The present disclosure involves the field of risk assessment, and in particular to methods and systems for loan risk assessment in a smart city based on the Internet of Things (IoT).

### BACKGROUND

With the development of the society, the behaviors of loan to buy houses and cars are very common, and banks or other institutions often need to assess the loan eligibility of a loan object. The traditional loan eligibility assessment may mainly be manually performed by banks or other institutions to assess the loan risk of the loan object from the credit status and financial status of the loan object itself based on the process. For example, the loan risk of the loan object may be calculated according to the credit status and a loan risk coefficient. However, other external factors may affect the loan risk assessment of the loan object, moreover, assessing the loan risks of different loan objects relying on a unified loan risk coefficient may fail to consider the situations of the different loan objects themselves. Obviously, loan eligibility assessment is a difficult task with low credibility. To facilitate risk control, it may be necessary to further review the loan eligibility of the loan object before the loan based on the situation of each loan object and comprehensively considering the impact of other people or factors other than the loan object on the loan risk of the loan object, so as to reduce the risk of the bank or other institutions.

Therefore, it is hoped to provide a method and system for loan risk assessment in a smart city based on the IoT, which may further accurately assess the loan risk of loan object based on the situation of the loan object and other people or factors.

### SUMMARY

One or more embodiments of the present disclosure provide a method for loan risk assessment in a smart city based on an Internet of Things (IoT). The method may include obtaining a risk query request from a financial service platform, the risk query request being generated in response to a loan request input by a loan object on a user platform; determining a related person of the loan object, an income and expenditure situation of which is similar to that of the loan object; in response to the risk query request, determining basic information of the loan object based on a population information platform, the basic information at least including income and expenditure information; obtaining a first loan information of the loan object and a second loan information of the related person based on the financial service platform; determining a loan risk of the loan object based on the basic information, the first loan information, and the second loan information; and sending the loan risk to the financial service platform.

One or more embodiments of the present disclosure provides a system for loan risk assessment in a smart city based on the IoT. The system includes the user platform and the government management platform. The government platform may be configured to perform the following operations: obtaining the risk query request from the financial service platform, the risk query request being generated in response to a loan request input by the loan object on the user platform; determining the related person of the loan object, the income and expenditure situation of which is similar to that of the loan object; in response to the risk query request, determining basic information of the loan object based on a population information platform, the basic information at least including income and expenditure information; obtaining the first loan information of the loan object and a second loan information of the related person based on the financial service platform; determining the loan risk of the loan object based on the basic information, the first loan information, and the second loan information; and sending the loan risk to the financial service platform.

One or more embodiments of the present disclosure provide a computer-readable storage medium storing computer instructions, when reading the computer instructions in the storage medium, a computer implements the method for loan risk assessment in a smart city based on the IoT.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating the application scenario of a system for loan risk assessment according to some embodiments of the present disclosure;

FIG. 2 is a module diagram illustrating a system for loan risk assessment according to some embodiments of the present disclosure;

FIG. 3 is an exemplary flowchart illustrating a method for loan risk assessment according to some embodiments of the present disclosure;

FIG. 4 is an exemplary flowchart illustrating the determining a related person based on a population information platform according to some embodiments of the present disclosure;

FIG. 5 is an exemplary schematic diagram illustrating the determining a related person based on a knowledge map according to some embodiments of the present disclosure;

FIG. 6 is an exemplary schematic diagram illustrating the determining an iteration process of a loan risk according to some embodiments of the present disclosure; and

FIG. 7 is an exemplary schematic diagram illustrating the determining a loan risk based on a prediction model according to some embodiments of the present disclosure.

### DETAILED DESCRIPTION

In order to illustrate technical solutions of the embodiments of the present disclosure, a brief introduction regarding the drawings used to describe the embodiments is provided below. Obviously, the drawings described below are merely some examples or embodiments of the present disclosure. Those having ordinary skills in the art, without further creative efforts, may apply the present disclosure to other similar scenarios according to these drawings. It should be understood that the exemplary embodiments are provided merely for better comprehension and application of the present disclosure by those skilled in the art, and not intended to limit the range of the present disclosure. Unless obvious according to the context or illustrated specifically, the same numeral in the drawings refers to the same structure or operation.

It should be understood that the terms “system”, “device”, “unit” and/or “module” used in the specification are means used to distinguish different assemblies, elements, parts, segments, or assemblies. However, these words may be replaced by other expressions if they serve the same purpose.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or assemblies, but do not preclude the presence or addition of one or more other features, integers, steps, operations, elements, assemblies, and/or groups thereof.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added into the flowcharts. One or more operations may be removed from the flowcharts.

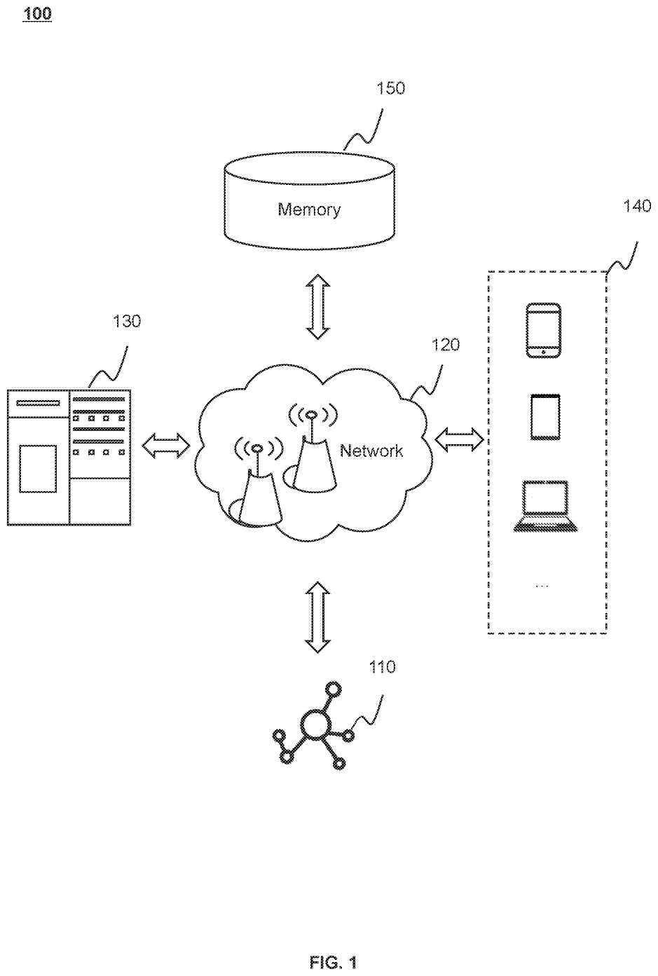

FIG. 1 is a schematic diagram illustrating the application scenario of a system for loan risk assessment according to some embodiments of the present disclosure.

As shown in FIG. 1, a loan risk assessment system 100 may include an offline cloud platform 110, a network 120, a processor 130, a terminal 140, a memory 150. In some embodiments, assemblies in the loan risk assessment system 100 may connect and/or communicate with each other through the network 120 (such as wireless connection, wired connection, or the combination thereof). For example, the processor 130 may be connected to the memory 150 through the network 120.

The loan risk assessment system 100 may determine a loan risk of a loan object through the methods and/or processes disclosed in the present disclosure. Specifically, when the loan object is willing to loan, the financial service platform may request the loan risk assessment system to determine the loan risk of the loan object based on basic information of the loan object, loan information (e.g., first loan information, second loan information) of the loan object and its related person.

The offline cloud platform 110 may be a cloud computing platform that communicates with the loan risk assessment system. It may be configured for data storage and processing. In some embodiments, the offline cloud platform 110 may include a financial service platform and a population information platform, etc. The population information platform may refer to a cloud platform or an external database that records relevant information (such as, the basic information, etc.) of the loan objects. In some embodiments, the processor 130 may obtain the basic information of the loan object based on the population information platform. In some embodiments, the processor 130 may determine the related person of the loan object based on the population information platform. The financial service platform may refer to a cloud platform or an external database that records the relevant information (e.g., the first loan information, the second loan information) of the loan objects and the related people. In some embodiments, the processor 130 may determine the first loan information of the loan object and the second loan information of the related person based on the financial service platform. In some embodiments, the offline cloud platform 110 may communicate and exchange data with the processor 130, the terminal 140, and the memory 150 through the network 120. For example, the offline cloud platform 110 may send the obtained basic information, first loan information, and second loan information to the processor 130 for processing, and/or send the basic information, the first loan information, and the second loan information to the memory 150 for storage.

The network 120 may include any suitable network that may facilitate information and/or data exchange of each assembly of the loan risk assessment system 100. One or more assemblies in the loan risk assessment system 100 (for example, the cloud platform, the processor 130, the terminal 140, and the memory 150) may exchange data and/or information through the network 120. For example, the network 120 may send the basic information, the first loan information, and the second loan information of the loan object obtained from the offline cloud platform 110 to the processor 130. In some embodiments, the network 120 may be any one or both of the wired network or the wireless network. In some embodiments, the network 120 may include one or more network access points. For example, the network 120 may include wired or wireless network access points. In some embodiments, the topological structure of the network may be point-to-point, shared, centralized, etc., or a combination of a plurality of topological structures.

The processor 130 may process data and/or information related to the loan risk assessment system. In some embodiments, the processor 130 may access information and/or data from the offline cloud platform 110, the terminal 140, and/or the memory 150. For example, the processor 130 may obtain the basic information of the loan object, the loan information of the loan object and the related person, etc. from the offline cloud platform 110 and/or from the memory 150. In some embodiments, the processor 130 may process the information and/or data obtained from the offline cloud platform 110 and/or the memory 150. For example, the processor 130 may process the basic information, the first loan information, and the second loan information obtained from the offline cloud platform 110 to determine the loan risk of the loan object. In some embodiments, the processor 130 may include one or more processing engines (such as, a single-chip processing engine or a multi-chip processing engine). As an example, the processor 130 may include a central processing unit (CPU). The processor 130 may process the data, information, and/or processing results obtained from other devices or system components, and execute program instructions based on the data, information, and/or processing results to perform one or more functions described in the present disclosure.

The terminal 140 may refer to one or more terminal devices or software used by the user. In some embodiments, the terminal 140 may be mobile devices, tablet computers, laptops, etc. or any combinations thereof. In some embodiments, the terminal 140 may interact with other assemblies in the loan risk assessment system 100 through the network 120. In some embodiments, the terminal 140 may be terminal devices or software used by the loan object.

The memory 150 may be configured to store data, instructions, and/or any other information. In some embodiments, the memory 150 may store data and/or information obtained from, for example, the processor 130, the offline cloud platform 110, etc. For example, the memory 150 may store the basic information, the first loan information, the second loan information, and a knowledge map, etc. of the loan object. In some embodiments, the memory 150 may be configured in the processor 130. In some embodiments, the memory 150 may include a bulky memory, a removable memory, etc. or any combinations thereof.

It should be noted that the loan risk assessment system 100 is only provided for the purpose of explanation, and not intend to limit the scope of the present disclosure. For those skilled in the art, a variety of modifications or changes may be made according to the description of the present disclosure. For example, the application scenarios may further include databases. For another example, the loan risk assessment system 100 may achieve similar or different functions on other devices. However, these changes and modifications may not deviate from the scope of the present disclosure.

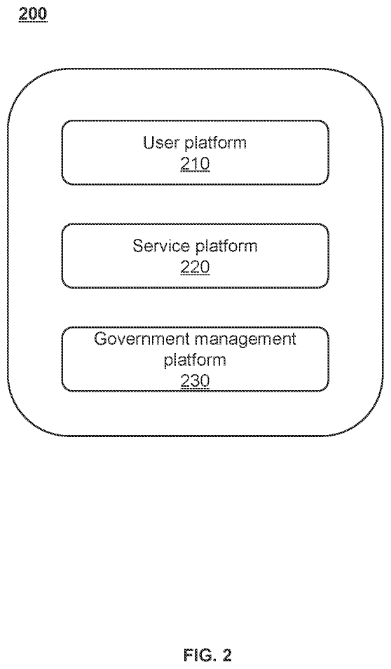

FIG. 2 is a module diagram illustrating a system for loan risk assessment according to some embodiments of the present disclosure.

As shown in FIG. 2, a loan risk assessment system 200 includes a user platform 210 and a government management platform 230. In some embodiments, the loan risk assessment system 200 may be part of a processor 130 or may be implemented by the processor 130.

In some embodiments, the loan risk assessment system 200 may be operated based on a government management Internet of Things (IoT). The government management IoT may refer to an information processing system that includes a part or all platforms of the user platform 210, the service platform 220, and the government management platform 230. The information process in the government management IoT may be divided into a processing flow of perception information and processing flow of control information, and the control information may be information generated based on the perceptual information. The processing of the perceptual information may be that the user platform 210 obtains the perceptual information and sends the perceptual information to the government management platform 230. The control information may be issued by the government management platform 230 to the user platform 210, thereby realizing the control of a corresponding user. In some embodiments, when applying the IoT system to urban management, it may be called the IoT system in a smart city.

The user platform 210 may be a platform for interacting with the user. In some embodiments, the user platform 210 may be configured as a terminal device (for example, the terminal 140), for example, the terminal devices may include a mobile device, a tablet computer, etc., or any combinations thereof. In some embodiments, the user platform 210 may be used to receive requests and/or instructions input by the user. For example, when the user requests a loan toward a financial service platform, the user platform 210 may obtain the user's loan request through the terminal device.

The service platform 220 may be a platform for receiving and transmitting data and/or information. For example, the service platform 220 may obtain a loan request from the user platform 210. Furthermore, the service platform 220 may send the loan request of a loan object to the financial service platform. In some embodiments, the financial service platform may generate a risk query request according to the user's loan request. More descriptions about the financial service platform may be referred to FIG. 1 and related descriptions.

The government management platform 230 may refer to a platform performing an overall planning coordination of a connection and collaboration between each functional platform, gathering all information of loan risk assessment system 200, and providing a function of operating a perceptual management and a control management for the loan risk assessment system 200. In some embodiments, the government management platform 230 may communicate with an offline cloud platform 110 (for example, a population information platform, the financial service platform, etc.) to obtain data and/or information. For example, the government management platform 230 may obtain user's risk query requests through the financial service platform. For example, the government management platform 230 may determine a related person of the loan object based on the population information platform and/or the financial service platform, and in response to the risk query request, determine basic information of the loan object based on the population information platform; determine a first loan information of the loan object and a second loan information of the related person based on the financial service platform. More descriptions about the population information platform and the financial service platform may be referred to FIG. 1 and related descriptions. In some embodiments, the government management platform 230 may process the received data and/or information. For example, the government management platform 230 may determine the loan risk of the loan object based on the basic information of the loan object, the first loan information of the loan object, and the second loan information of the related person, and may feedback the loan risk to the financial service platform. In some embodiments, the government management platform 230 may include the processor 130 and other assemblies in FIG. 1. In some embodiments, the government management platform 230 may be a remote platform controlled by management personnel, artificial intelligence, or preset rules.

In some embodiments, the loan risk assessment system 200 may be applied to a variety of scenarios of the loan risk assessment. For example, a new user loan scenario, an old user loan scenario, etc. It should be noted that the above scenarios are only for a purpose of illustration, and do not restrict the specific application scenarios of the loan risk assessment system 200. Those skilled in the art may apply the loan risk assessment system 200 to any appropriate scenarios on the basis of the content disclosed in the present embodiment. In a variety of application scenarios when the loan risk assessment system 200 is applied to the loan risk assessment, the related person of the loan object may be determined through a knowledge map or other modes, and considering a degree of mutual influence between the loan risks of the loan object and the related person, an auxiliary assessment may be further performed on the loan risk of the loan object according to the related person. For example, the source of income of employees of the same working unit may be regarded as basically the same. Therefore, when a financial difficulty exists in the working unit, the employees repaying the loan in the working unit may have higher risks of loan overdue. When the industry's economic downturn and fluctuate, the units belonging to the industry may be affected, and the employees repaying the loan in the industry may have higher risks of loan overdue. Therefore, the loan risk assessment system 200 may help banks and other loan institutions to determine the risk of loan objects, so as to ensure the reliability of the loans and avoid losses to the loan institutions caused by loan overdue.

Exemplarily, in the new user loan scenario, relevant personnel of the financial service platform may assess a first loan risk (the risk of first loan) of the new user (i.e., the loan object) to determine the loan risk of the new user. In the process of assessing the loan risk of the new user, the related person of the new user may be obtained through the knowledge map or other modes, and according to the basic information (e.g., income and expenditure information, etc.) of the new user, the loan information (e.g., historical repaying information, loan basic information, other credit information) of the new user, and the loan information of the related person, the first loan risk of the new user may be determined.

Exemplarily, in the old user loan scenario, the relevant personnel of the financial service platform may assess the renewal risk (the risk of loan again) of the old user (i.e., loan objects) to determine the loan risk of the old user. In the process of assessing the renewal risk of the old user, the renewal risk of the old user may be determined by obtaining the related person of the old user, as well as the basic information of the old user, historical loan information (e.g., historical repaying information, loan basic information, other credit information) of the old user during a historical loan period, and loan information of the related person of the old user through the knowledge map or other modes.

In some embodiments, the loan risk assessment system 200 may be composed of a plurality of loan risk assessment sub-systems, and each sub-system may be applied to a scenario. The loan risk assessment system 200 may comprehensively manage and process the data obtained and output by each sub-system, thereby obtaining relevant strategies or instructions for the auxiliary of the loan risk assessment. For example, the loan risk assessment system 200 may include sub-system applied to the new user loan scenario and subsystem applied to the old user loan scenario. The loan risk assessment system 200 may be a superior system for each sub-system.

For those skilled in the art, after understanding the principle of the system, the system may be applied to any other appropriate scenarios without departing from this principle.

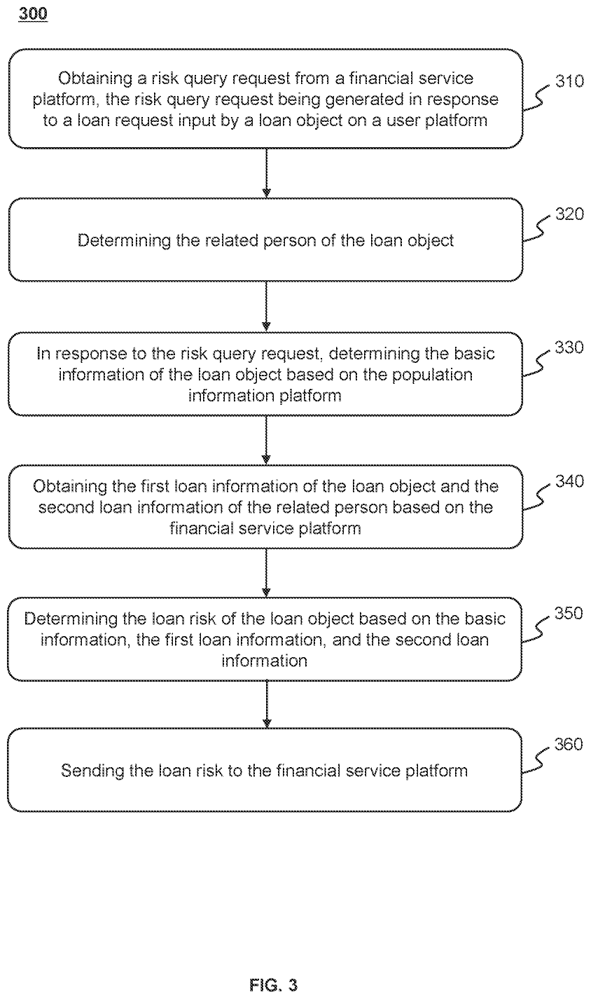

In some embodiments, the government management platform 230 may be configured to: obtain the risk query request from the financial service platform, and the risk query request may be generated in response to the loan request input by the loan object in the user platform; determine the related person of the loan object; in response to the risk query request, determine the basic information of the loan object based on the population information platform; obtain the first loan information of the loan object and the second loan information of the related person based on the financial service platform; determine the loan risk of the loan object based on the basic information, the first loan information, and the second loan information; and send the loan risk to the financial service platform. More descriptions about the risk query request, the loan object, the loan request, the basic information, the income and expenditure information, the first loan information, the second loan information, and the loan risk may be referred to FIG. 3 and related descriptions.

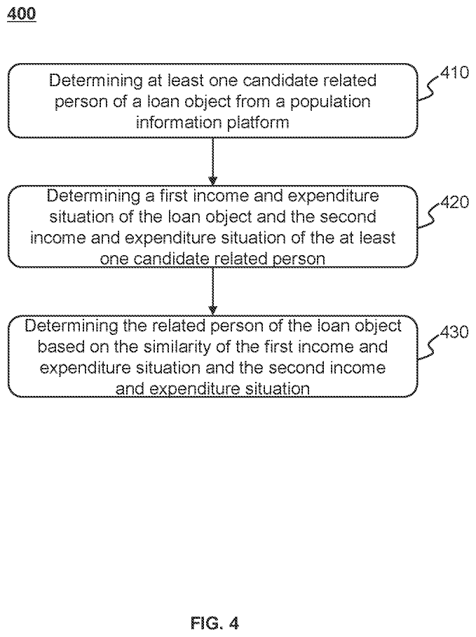

In some embodiments, the government management platform 230 may be configured to further perform the following operations: determining at least one candidate related person of the loan object from the population information platform; determining a first income and expenditure situation of the loan object and a second income and expenditure situation of the at least one candidate related person; and determining, based on a similarity of the first income and expenditure situation and the second income and expenditure situation, the related person of the loan object. More descriptions about the candidate related person, the first income and expenditure situation, and the second income and expenditure situation may be referred to FIG. 4 and the related descriptions.

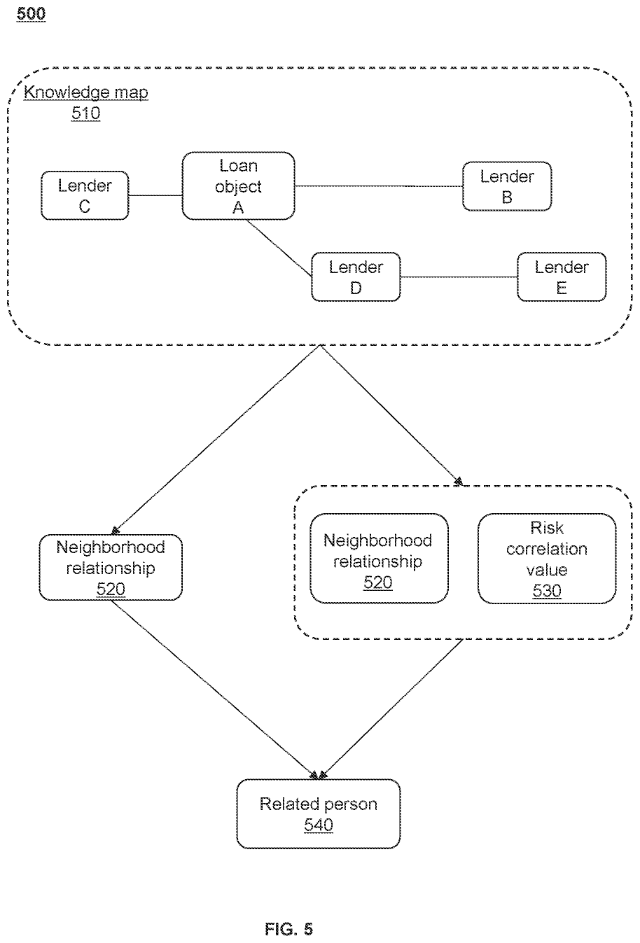

In some embodiments, the government management platform 230 may be configured to further perform the following operations: constructing the knowledge map based on relevant information of the loan object and relevant information of each lender in the financial service platform; taking the loan object and each lender as nodes of the knowledge map, node feature being the first load information of the loan object or the loan information corresponding to the lender; constructing edges of the knowledge map according to the similarity of the income and expenditure information between the loan object and each lender, an edge feature being the similarity of the income and expenditure information; and determining the related person of the loan object based on a neighborhood relationship. More descriptions about determining the related person based on the knowledge map may be referred to FIG. 5 and its related descriptions.

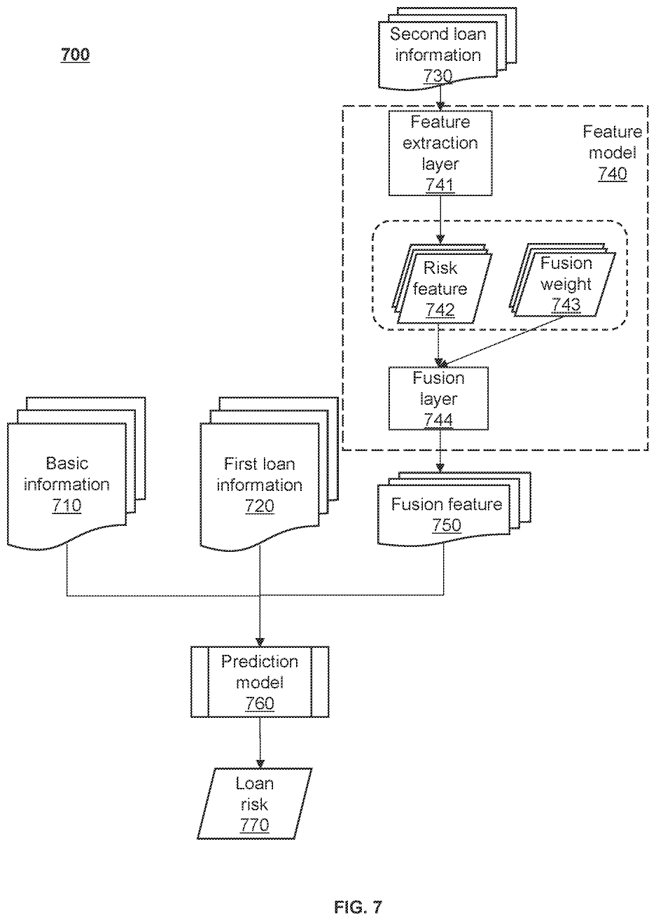

In some embodiments, the government management platform 230 may be configured to further perform the following operations: processing the basic information, the first loan information, and the second loan information based on a prediction model to determine the loan risk of the loan object. More descriptions about the prediction model may be referred to FIG. 7 and its related descriptions.

It should be noted that the above descriptions of the system and its components are only for the purpose of description, and not limit the scope of the embodiments of the present disclosure. It is understandable that for those skilled in the art, after understanding the principle of the system, arbitrarily combinations may be made to each component or sub-systems may be formed to connect with other compositions without departing from this principle. For example, each component may share a memory, or each component may further have their own memory. Such deformations are within the protection range of the present disclosure.

FIG. 3 is an exemplary flowchart illustrating a method for loan risk assessment according to some embodiments of the present disclosure. In some embodiments, the method for loan risk assessment may be performed by the loan risk assessment system 100 (for example, the processor 130) or the loan risk assessment system 200 (e.g., the government management platform 230). For example, the method for loan risk assessment may be stored in a storage device (for example, the memory 150) in the form of a program or an instruction. When the processor 130 or the government management platform 230 performs the program or the instruction, a process 300 may be implemented. The operation schematic diagram of the process 300 presented hereinafter may be illustrative. In some embodiments, one or more unexplained additional operations and/or one or more operations that are not discussed may be used to complete the process. In addition, the order of the operations of the process 300 described in FIG. 3 is not restrictive.

In 310, obtaining a risk query request from a financial service platform, the risk query request being generated in response to a loan request input by a loan object on a user platform. In some embodiments, the operation 310 may be performed by the government management platform 230.

The financial service platform may refer to a cloud platform or a database that may provide a financial activity service, for example, a bank database, an insurance company's cloud platform, etc. In some embodiments, the financial service platform may be an offline cloud platform or an external database. The financial service platform may communicate with at least one platform (such as the user platform 210, the government management platform 230, etc.) in the loan risk assessment system 200, and the government management platform 230 may obtain data from the financial service platform, for example, the risk query request.

The risk query request may refer to a request for querying a loan risk of the loan object. For example, it may be a request for an overdue risk of loan repayment of the loan object.

The loan object may refer to a unit and an individual who applies for a loan, for example, a resident applying for a consumer loan, a company applying for a business loan, etc.

The loan request may refer to a loan application issued by the loan object. In some embodiments, the loan requests may include loan object information (such as a name, an ID number, a working unit, contact information, an income, etc.), loan types (such as a credit loan, a guaranteed loan, etc.), loan purpose (such as furnishing, buying a house, doing business, etc.), loan amount (such as 100,000 yuan, 2 million yuan, etc.), the loan term (such as 3 years, 30 years, etc.), etc.

In some embodiments, the government management platform 230 may obtain the risk query request from the financial service platform. The risk query requests may be generated in respond to the loan request input by the loan object on the user platform 210. Exemplarily, the user platform 210 may receive a loan request input by the loan object through a terminal device. After receiving the loan request for the user platform 20, the loan request may be sent to the financial service platform. The financial service platform may generate a corresponding risk query request based on the loan request.

In 320, determining the related person of the loan object. In some embodiments, the operation 320 may be performed by the government management platform 230.

A related person may refer to a person or a working unit related to the loan object, for example, a family member, a company colleague, and a person or a working unit with other social relationships (such as a person or a company in the same industry). In some embodiments, an income and expenditure situation of the related person may be similar to that of the loan object. Correspondingly, the government management platform 230 may determine the person or working unit with a similar income and expenditure situation to the loan object as a related person of the loan object.

The income and expenditure situation may refer to information that reflects the income and expenditure of the loan object and whether the income is stable. In some embodiments, the income and expenditure situation may include income and expenditure information (such as monthly income, monthly expenditure, and expenditure ratio, etc.), the working unit (such as a school, a hospital, an enterprise, etc.), and an industry feature (such as the stable industry's income throughout the year, the industry's income vulnerable to external influences, etc.). Correspondingly, an income and expenditure situation of the related person similar to that of the loan object may refer to that the income and expenditure information, the working unit, and/or the industry feature of the related person may be similar to that of the loan object. In some embodiments, the income and expenditure situation of the related person similar to that of the loan object may be represented by similarity. More descriptions about the income and expenditure information may be referred to the operation 330 and related descriptions. More descriptions about the similarity may be referred to FIG. 4 and its related descriptions.

In some embodiments, the government management platform 230 may determine at least one candidate related person of the loan object from a population information platform and determine the related person of the loan object based on the similarity between the first income and expenditure situation of the loan object and the second income and expenditure situation of the candidate related person. More descriptions about the above embodiments may be referred to FIG. 4 and its related descriptions.

In some embodiments, the government management platform 230 may further construct the knowledge map based on the relevant information of the loan object and the relevant information of each lender in the financial service platform and determine the related person of the loan object based on the neighborhood relationship of the knowledge map. More descriptions about the similarity may be referred to FIG. 5 and its related descriptions.

In 330, in response to the risk query request, determining the basic information of the loan object based on the population information platform. In some embodiments, the operation 330 may be performed by the government management platform 230.

The population information platform refers to a cloud platform or a database that records the basic information of the population, for example, a national population information platform, a bank user database, etc. In some embodiments, the population information platform may be an offline cloud platform or an external database. The population information platform may communicate with at least one platform (such as the user platform 210, the government management platform 230, etc.) of the loan risk assessment system 200. In some embodiments, the government management platform 230 may obtain data from the population information platform, such as the basic information of the loan object. More descriptions about the population information platform may be referred to FIG. 1 and its related descriptions.

The basic information refers to the information that reflects the basic situation of the population. In some embodiments, the basic information at least includes the income and expenditure information. In some embodiments, the basic information may further include information such as a gender, an age, family information, the working unit, the industry, etc.

The income and expenditure information refer to the income and expenditure situation within a period of time, for example, the income and expenditure situation within a year, the income and expenditure situation within a month, etc. In some embodiments, the income and expenditure information may be obtained by a bank deposit and withdrawal transaction record, a wage transaction history, etc.

In some embodiments, the income and expenditure information may include the income, the expenditure, and the expenditure ratio. The expenditure ratio may reflect the ratio of various types of expenditures to the income within a period of time, for example, the ratio of daily necessities to the total income. In some embodiments, the ratio of expenditure may include an annual expenditure ratio and a monthly expenditure ratio. In some embodiments, the ratio of expenditure may further include the ratio of daily necessities expenditure, the ratio of residential expenditure, the ratio of tourism expenditure, and the ratio of medical care expenditure. In some embodiments, the ratio of expenditure may be represented by an expenditure ratio vector. Each element of the consumption ratio vector may represent the ratio of a type of expenditure. As an example, the consumption ratio vector may be represented as (a, b, c, d, . . . ), where “a” may represent the ratio of daily necessities expenditure (for example, when the ratio of daily necessities expenditure is 0˜10%, the corresponding “a” may be 1, when the ratio of daily necessities expenditure is 10˜20%, the corresponding “a” may be 2, etc.); “b” may represent the ratio of residential expenditure (for example, when the ratio of residential expenditure is 0˜10% the corresponding “b” may be 1, when the ratio of residential expenditure is 10˜20%, the corresponding “b” may be 2, etc.); “c” may represent the ratio of health care expenditure (for example, when the ratio of health care expenditure is 0˜10%, the corresponding “c” may be 1, when the ratio of residential expenditure is 10˜20%, the corresponding “c” may be 2, etc.); d may represent the ratio of tourism expenditure (for example, when the ratio of tourism expenditure is 0˜10%, the corresponding “d” may be 1, when the ratio of tourism expenditure is 10˜20%, the corresponding “d” may be 2, etc.).

In some embodiments, the government management platform 230 may determine the basic information of the loan object who issues the risk query request in the population information platform in response to the risk query request. For example, a risk query request may be used for querying the loan risk of loan object A, then the government management platform 230 may obtain the basic information of the loan object A (such as gender being female, age being 30, annual income being 100,000 yuan, annual expenditure being 50,000 yuan, working at a school in the education industry, etc.) from the population information platform.

In 340, obtaining the first loan information of the loan object and the second loan information of the related person based on the financial service platform. In some embodiments, the operation 340 may be performed by the government management platform 230.

The first loan information may refer to a loan situation of the loan object, and the second loan information may refer to the loan situation of the related person. In some embodiments, the first loan information and the second loan information may include the loan basic information, the historical repaying information, and other credit information. The loan basic information may include a loan mode (e.g., a commercial loan, a pure provident fund loan, a combined loan, etc.), a repaying mode (e.g., equal principal, equal principal and interest, etc.), a loan term (e.g., 5 years, 20 years, 30 years, etc.), a loan interest rate (e.g., 4.35%, 6.15%, etc.), a current monthly loan payment (e.g., 5000 yuan, 7000 yuan, etc.), an estimated corresponding monthly payment of the loan request (e.g., 3000 yuan, 10000 yuan, etc.). The historical repaying information may include a total number of overdues, total overdue days, and a number of loan repayments of historical loans. Other credit information may include the number of credit cards that have been opened, the number of credit card overdue recently (e.g., recent 3 years, recent 1 year), and a number of times to apply for small loans (such as loans below 10,000 yuan).

In some embodiments, the government management platform 230 may obtain the first loan information of the loan object and the second loan information of the related person based on the financial service platform. Exemplarily, the government management platform 230 may be call the first loan information of the loan object and the second loan information of the related person stored in the financial service platform after confirming the loan object and the related person of the loan object.

In 350, determining the loan risk of the loan object based on the basic information, the first loan information, and the second loan information. In some embodiments, the operation 350 may be performed by the government management platform 230.

The loan risk refers to the risk that the loan object is overdue or unable to repay the loan. In some embodiments, the loan risk may be represented by different risk levels, for example, “low”, “middle”, “high”, and so on. In some other embodiments, the loan risk may be represented by a value, for example, the loan risk may be represented as a value within a range of 0-100%. Correspondingly, the higher the value of the loan risk is, the higher the loan risk is.

In some embodiments, the government management platform 230 may process the basic information, the first loan information, and the second loan information based on a prediction model to determine the loan risk of the loan object. More descriptions about the above embodiments may be referred FIG. 7 and its related descriptions.

In 360, sending the loan risk to the financial service platform. In some embodiments, the operation 360 may be performed by the government management platform 230.

In some embodiments, the government management platform 230 may send the loan risk to the financial service platform after determining the loan risk. The financial service platform may determine whether to provide loans for the loan object based on the loan risk.

The methods described in some embodiments of the present disclosure may assess the loan risk of the loan object based on the related person, which helps banks and other loan institutions to determine the risk of the lender and ensures the reliability of loans, thereby avoiding overdue situations and the losses to the loan institutions.

FIG. 4 is an exemplary flowchart illustrating the determining a related person based on a population information platform according to some embodiments of the present disclosure. In some embodiments, a method for loan risk assessment may be performed by the loan risk assessment system 100 (e.g., the processor 130) or the loan risk assessment system 200 (e.g., the government management platform 230). For example, the method for loan risk assessment may be stored in a storage device (for example, the memory 150) in the form of a program or an instruction. When the processor 130 or the government management platform 230 performs the program or the instruction, the process 400 may be implemented. The operation schematic diagram of the process 400 presented hereinafter may be illustrative. In some embodiments, one or more unexplained additional operations and/or one or more operations that are not discussed may be used to complete the process. In addition, the order of the operations of the process 400 described in FIG. 4 is not restrictive.

In 410, determining at least one candidate related person of a loan object from a population information platform. In some embodiments, the operation 410 may be performed by the government management platform 230.

The candidate related person may refer to a candidate personnel used to determine the related person of the loan object. For example, the candidate related person may be a family member, a colleague, a colleague of the family member, a family member of the colleague, or a person of other social relationships of the loan object.

In some embodiments, the government management platform 230 may determine at least one candidate related person of the loan object from the population information platform based on the basic information of the loan object. For example, the government management platform 230 may determine a colleague of the loan object as a candidate related person of the loan object based on a working unit of the loan object. For another example, the government management platform 230 may determine a spouse and parents of the loan object as a candidate related person of the loan object based on family information of the loan object.

In 420, determining a first income and expenditure situation of the loan object and the second income and expenditure situation of the at least one candidate related person. In some embodiments, the operation 420 may be performed by the government management platform 230.

The first income and expenditure situation may refer to an income and expenditure situation of the loan object. For example, the first income and expenditure situation may be a monthly income, a monthly expenditure, and a monthly expenditure ratio of the loan object. For another example, the first income and expenditure situation may be the working unit and an industry feature of the loan object.

The second income and expenditure situation may refer to the income and expenditure of the candidate related person. For example, the second income and expenditure situation may be the monthly income, a monthly consumption, and a consumption ratio vector of the candidate related person. For another example, the second income and expenditure may be the working unit and the industry feature of the candidate related person. More descriptions about the income and expenditure situation may be referred to FIG. 3 and its related descriptions.

In some embodiments, the first income and expenditure situation and the second income and expenditure situation may be represented by vectors (referred to as the first income and expenditure vector and the second income and expenditure vector hereinafter). In some embodiments, the elements of the income vector, the expenditure vector, and the expenditure ratio vector may be spliced into one vector to indicate the first income and expenditure situation and the second income and expenditure situation. Correspondingly, the first income and expenditure situation may be determined by determining the vector. As an example, the first income and expenditure situation and the second income and expenditure situation may be expressed as (A, B, C), where A may represent the income of income and expenditure information, B may represent the expenditure of the income and expenditure information, and C may represent the ratio of the expenditure in the income and expenditure information. For example, the monthly income of a loan object A is 8,000 yuan, its monthly expenditure is 6,000 yuan, and the expenditure ratio is 75%, then the first income and expenditure vector a may be (0.8, 0.6, 0.75); the monthly income of a candidate related person B is 100,000 yuan, its monthly expenditure is 6,000 yuan, and the monthly expenditure ratio is 60%, then the second income and expenditure vector b may be (1, 0.6, 0.6), etc.

In some embodiments, the income, the expenditure, and the expenditure ratio in the income and expenditure information, and the working unit and the industry feature of the loan object may further be used as the elements of the vector, and a variety of the elements may be spliced into a vector to indicate the first income and expenditure situation and the second income and expenditure situation. Correspondingly, the first income and expenditure situation and the second income and expenditure situation may be determined by determining the vector. As an example, the first income and expenditure situation and the second income and expenditure situation may be represented as (A, B, C, D, E, . . . ), where A may represent the income of the income and expenditure information, B may represent the expenditure of the income and expenditure information, C may represent the expenditure ratio in the income and expenditure information, D may represent the working unit, E may represent the industry feature, etc. The elements D and E may be determined according to a preset comparison table. For example, when the working unit is a law firm, the corresponding D may be 1; when the working unit is an accounting firm, the corresponding D may be 2, etc. When the industry feature is an industry economic downturn, the corresponding E may be 1; when the industry feature is an industry economic prosperity, the corresponding E may be 2.

In 430, determining the related person of the loan object based on the similarity of the first income and expenditure situation and the second income and expenditure situation. In some embodiments, the operation 430 may be performed by the government management platform 230.

The similarity of the first income and expenditure situation and the second income and expenditure situation may represent the similarity between the loan object and the candidate related person on the income and expenditure situation. In some embodiments, a vector distance between the first income and expenditure vector and the second income and expenditure vector may represent the similarity of the first income and expenditure situation and the second income and expenditure situation. For example, the smaller the vector distance is, the higher the similarity of the first income and expenditure situation and the second income and expenditure situation is; the greater the distance is, the lower the similarity of the first income and expenditure situation and the second income and expenditure situation is.

In some embodiments, the government management platform 230 may determine the similarity between the first income and expenditure situation and the second income and expenditure situation based on the similarity of the income and expenditure information, the working unit similarity, and the industry feature similarity.

The similarity of the income and expenditure information may be the similarity between the income and expenditure information of the loan object and the income and expenditure information of the candidate related person. In some embodiments, the similarity of the income and expenditure information may be determined by the vector distance between the vector composed by the vector elements related to the income and expenditure information in the first income and expenditure vector and the second income and expenditure vector. In some embodiments, in the first income and expenditure vector and the second income and expenditure vector, different weights may be set for different vector elements. For example, for the first income and expenditure vector or the second income and expenditure vector (A, B, C), the corresponding weight of the element A may be set to be 0.5, the corresponding weight of the element B may be set to be 0.3, and the corresponding weight of the element C may be set to be 0.2. It may be understood that when determining the similarity of the income and expenditure information, the importance of the income and the expenditure in the income and expenditure information is higher than the importance of the expenditure ratio. Therefore, the weights corresponding to the income and the expenditure may be greater than the weight corresponding to the expenditure ratio.

The working unit similarity may be similarity between the working unit of the loan object and the working unit of the candidate related person. For example, when the working unit of the loan object is the same as the working unit of the candidate related person, the corresponding working unit similarity may be 1; and when the working unit of the loan object is different from the working unit of the candidate related person, the corresponding working unit similarity may be 0.

The industry feature similarity may be the similarity between the industry of the loan object and the industry of the candidate related person. For example, when the industry features of the loan object and the candidate related person are the same, the corresponding industry feature similarity may be 1; and when the industry features of the loan object and the candidate related person are different, the corresponding industry feature similarity may be 0.

In some embodiments, on the basis of determining the similarity of the income and expenditure information, the government management platform 230 may determine a growth coefficient of the same working unit and a growth coefficient of the same industry respectively according to the working unit similarity and the industry feature similarity, so as to determine the final similarity. The growth coefficient of the same working unit may refer to the corresponding growth coefficient when the loan object and the candidate related person are the same working unit. Correspondingly, the growth coefficient of the same working unit may be 1 when they are not in the same working unit. The growth coefficient of the same industry may be the corresponding growth coefficient when the loan object and the candidate related person share the same industry features. Correspondingly, the growth coefficient of the same industry may be 1 when they have different industry features. In some embodiments, the growth coefficient of the same working unit and the growth coefficient of the same industry may be the same or different. The two may be pre-determined manually. For example, the growth coefficient of the same working unit may be 1.2, and the growth coefficient of the same industry may be 1.1.

Exemplarily, the similarity between the first income and expenditure situation and the second income and expenditure situation may be calculated through the following formula (1):

d=α×βm (1),

where d denotes the similarity between the first income and expenditure situation and the second income and expenditure situation, α denotes the growth coefficient of the same working unit, β denotes the growth coefficient of the same industry, and m denotes the similarity of the income and expenditure information. For example, when the similarity of the income and expenditure information between the loan object and the candidate related person is 50%, the loan object has the same working unit with the candidate related person, and growth coefficient of the same working unit is 1.2, the industry features between the loan object and the candidate related person are the same, and the growth coefficient of the same industry is 1.1, the corresponding similarity may be 66%.

In some embodiments, the government management platform 230 may determine the related person of the loan object according to the relationship between a similarity threshold and the similarity between the first income and expenditure situation and the second income and expenditure situation. The similarity threshold may be a system default value, an experience value, a manual preset value, etc. or any combination thereof, which may be set according to actual needs. The present disclosure does not limit it.

In some embodiments, when the similarity between the first income and expenditure situation and the second income and expenditure situation is greater than the similarity threshold, the corresponding candidate related person may be determined as the related person of the loan object. For example, the similarity threshold of the income and expenditure situation is 70%, when the similarity between the first income and expenditure situation of the loan object A and the second income and expenditure situation of the candidate related person B is greater than the similarity threshold, the candidate related person B may be determined as the related person of the loan object A.

In some embodiments of the present disclosure, the related person of the loan object may be determined through the similarity of the income and expenditure information, the working unit similarity, and the industry feature similarity, which may accurately determine the related person of the loan object, so as to facilitate the continuous assessment on the loan risk of the loan object combined with the relevant situation of the related person. For example, employees of the same working unit may be regarded as basically having the same source of income, so when the working unit has difficulty in funding, employees in the working unit who are repaying loans may have a high risk of loan overdue; when the industry's economic downturn or fluctuate, the units belonging to the industry may all be impacted, and employees in the industry who are repaying loans may have a high risk of loan overdue.

In some embodiments, the government management platform 230 may construct a knowledge map based on relevant information of the loan object and relevant information of each lender in the financial service platform.

The relevant information of the loan object refers to the information related to the loan object. In some embodiments, the relevant information of the loan object may include the basic information and the first loan information of the loan object.

The lender refers to person who initiates loan requests other than the loan object, for example, lenders B, C, D, and E in FIG. 5.

The relevant information of the lender refers to the information related to the lender. In some embodiments, the relevant information of the lender may include the basic information and loan information of the lender.

In some embodiments, the government management platform 230 may take the loan object and the lenders as the nodes of the knowledge map. Correspondingly, the node features are the first loan information of the loan object or the loan information of the lenders.

In some embodiments, the government management platform 230 may construct the edges of the knowledge map according to the similarity of the income and expenditure information between each node. In some embodiments, when the similarity of the income and expenditure information between the two nodes is greater than a threshold, the two nodes may be connected by an edge. Correspondingly, an edge feature may be the similarity of the income and expenditure information. More explanations about how to determine the similarity of income and expenditure information may be referred to FIG. 4 and its related contents.

In some embodiments, the edge features of the knowledge map may further include the working unit similarity and the industry feature similarity. For example, when the working units of the persons corresponding to the two nodes are the same, the corresponding working unit similarity may be 1; when their working units are different, the corresponding working unit similarity may be 0. For another example, when the industry features of the persons corresponding to the two nodes are the same, the corresponding industry feature similarity may be 1; when their industry features are different, the corresponding industry feature similarity may be 0.

In some embodiments, the edge features of the knowledge map may be represented by a correlation. The correlation may refer to the similarity of the income and expenditure situations between each lender. In some embodiments, the correlation may be obtained by a weighted calculation of the similarity of the income and expenditure information, the working unit similarity, and the industry feature similarity. It should be understood that the correlation may be obtained by adopting the same implementation mode as the aforementioned determination of the similarity of the income and expenditure situations. More explanations about how to determine the similarity of the income and expenditure situations may be referred to FIG. 4 and its related contents.

In some embodiments, the government management platform 230 may determine a related person 540 of the loan object based on a neighborhood relationship 520 in a constructed knowledge map 510.

The neighborhood relationship may refer to the count of edges involved in the shortest path between the two nodes. For example, the neighborhood relationship is 0, indicating that there is no edge between the two nodes, the neighborhood relationship is 1, indicating that the shortest path between the two nodes involves one edge, and the neighborhood relationship is 2, indicating that the shortest path between the two nodes involves two edges. As shown in FIG. 5, the neighborhood relationships between loan object A and lenders B, C, and D may all be 1, and the neighborhood relationship between the loan object A and a lender E may be 2.

In some embodiments, the government management platform 230 may determine the related person 540 of the loan object according to the neighborhood relationship 520 and a preset neighborhood. The preset neighborhood may be a threshold condition that the neighborhood relationship between the two nodes needs to meet. The preset neighborhood may be a system default value, an experience value, a manual preset value, etc. or any combination thereof, which may be set according to actual needs. The present disclosure does not limit it. For example, the preset neighborhood may be 2. In some embodiments, the government management platform 230 may determine the lenders whose corresponding nodes meet the preset neighborhood as the related person of the loan object. Exemplarily, when the preset neighborhood is 1, the lender corresponding to the node whose neighbor relationship is 1 between the corresponding nodes of the loan object may be determined as the related person. As shown in FIG. 5, lenders B, C, and D, whose neighbor relationships with the loan object A are 1, may be determined as the related persons of the loan object A. When the preset neighborhood is 2, the lender corresponding to the node whose neighbor relationship is 2 between the corresponding nodes of the loan object may be determined as the related person. As shown in FIG. 5, lenders B, C, D, and E, whose neighbor relationships with the loan object A are 1 and 2, may be determined as the related persons of the loan object A.

In some embodiments, when the neighborhood relationship meets the preset neighborhood and the neighborhood relationship is greater than 1, the government management platform 230 may further determine whether the corresponding lender may be the related person 540 of the loan object based on the similarity of the income and expenditure information or the correlation between the nodes.

Exemplarily, when the neighborhood relationship meets the preset neighborhood and the neighborhood relationship is greater than 1, the government management platform 230 may take the lenders who meets the similarity of the income and expenditure information or whose correlation is greater than the preset threshold as the related persons 540 of the loan object.

Exemplarily, taking the similarity of the income and expenditure information as a criterion, when the neighborhood relationship is 2, as shown in FIG. 5, the similarity of the income and expenditure information of the loan object A and the lender E may be calculated through the following formula (2):

d_{AE}=d_{AD}×d_{DE} (2),

where d_{AE} denotes the similarity of the income and expenditure information between the loan object A and the lender E, d_{AD} denotes the similarity of the income and expenditure information between the loan object A and the lender D, and d_{DE} denotes the similarity of the income and expenditure information between the lender D and the lender E.

Correspondingly, if the similarity of the income and expenditure information between the loan object A and the lender E is greater than the preset threshold, the lender E may be taken as the related person of the loan object A. If the similarity of the income and expenditure information between the loan object A and the lender E is less than the preset threshold, the lender E may not be taken as the related person of the loan object A.

In some embodiments, the node features of the knowledge map 510 may further include the risk correlation value 530. Correspondingly, the government management platform 230 may determine the related person 540 of the loan object based on the neighborhood relationship 520 and the risk correlation value 530.

The risk correlation value 530 may reflect the degree of mutual influence of the loan risk of the loan object and the lender. For example, the risk correlation value may be represented by a certain value within the range of 0-1. When the loan risk of the loan object and the lender does not influence each other, the risk correlation value may be 0. When the loan risk of the loan object and the lender fully influences each other, the risk correlation value may be 1. The higher the risk correlation value is, the higher the degree of mutual influence on the loan risk is. In the knowledge map 510, the risk correlation value 530 may be used to reflect and determine the influence of each node on other nodes. The higher the risk correlation value is, the greater the influence of the node on other nodes is.

In some embodiments, when the neighborhood relationship 520 meets the preset neighborhood, the government management platform 230 may further determine the related person of the loan object 540 according to the relationship between the risk correlation value 530 and a preset correlation value. The preset correlation value may be a threshold condition that the risk correlation value between the two nodes needs to meet. The preset correlation value may be a default value, an experience value, a manual preset value, etc. or any combination thereof, which may be set according to actual needs. The present disclosure does not limit it. For example, the preset correlation value may be 0.2, as shown in FIG. 5, the neighborhood relationship between the lenders B, C, D and the loan object A meets the preset neighborhood, while the risk correlation values of the lenders B, C, and D are respectively 0.22, 0.18, and 0.34, then it may be determined that the risk correlation values of the lenders B and D meet the preset correlation value. Correspondingly, it may be determined that the lenders B and D may be the related persons of the loan object A.

In some embodiments, the risk correlation value may be updated through a plurality of iterations. To facilitate the explanation, the following will explain the specific contents of the iterations on the risk correlation value.

In the first iteration, for each node, a risk correlation value to be updated in the next iteration may be determined based on a total count of nodes, a count of connected nodes, and a risk correlation value to be updated of the connected nodes in the first iteration, the total count of the connected nodes may refer to the total count of the nodes in the knowledge map, the count of the connected nodes may refer to the total count of the nodes directly connected with the node (i.e., the neighborhood relationship being 1).

In some embodiments, the risk correlation value to be updated (i.e., the initial risk correlation value) of the connected nodes in the first iteration may be determined by performing weighted sums on the risk correlation value to be updated of each of the connected nodes in the first iteration. The risk correlation value to be updated of each of the connected nodes in the first iteration may be determined according to the total count of nodes of the knowledge map, and the weights may be determined based on the corresponding edge features. More contents about determining the weights may be referred to the descriptions of the following formula (5).

Exemplarily, in the first iteration, that is, when the time t=0, the risk correlation value to be updated of the node i in the first iteration may be calculated through the following formula (3):

$$PR ( {p}_{i} ; 0 ) = \frac{1}{N} , \qquad ( 3 )$$

where N denotes the total count of nodes of the knowledge map, (pᵢ; 0) indicates the node i when the time t=0, PR(pᵢ; 0) indicates the risk correlation value to be updated of the node i when the time t=0 (i.e., the initial risk correlation value).

In each of the subsequent iterations, for each node, the risk correlation value to be updated in the next iteration may be determined based on the total count of nodes, the count of the connected nodes, and the risk correlation value to be updated of the connected nodes in the current iteration. Exemplarily, the risk correlation value to be updated of at least one node connected to a certain node may be processed, and the risk correlation value to be updated of at least one node may be updated to obtain an updated risk correlation value. The updated risk correlation value may be taken as the risk correlation value to be updated of the at least one node in the next iteration.

Exemplarily, in each of the subsequent iterations, when the time is t+1, the risk correlation value to be updated of the node i may be calculated through the following formula (4):

$$PR ( {p}_{i} ; t + 1 ) = \frac{1 - d}{N} + d {\sum }_{{p}_{j} ∈ M ( {p}_{i} )} \frac{w ( {p}_{i} , {p}_{j} ) PR ( {p}_{j} ; t )}{degree ( {p}_{j} )} , \qquad ( 4 )$$

where d in

$$\frac{1 - d}{N}$$

(the first part or the formula (4) hereinafter) denotes a preset damping coefficient; degree(pⱼ) in

$$d {\sum }_{{p}_{j} ∈ M ( {p}_{i} )} \frac{w ( {p}_{i} , {p}_{j} ) PR ( {p}_{j} ; t )}{degree ( {p}_{j} )}$$

(the second part of the formula (4) hereinafter) denotes the degree of the node j, which is used to denote a count of edges connected directly or indirectly to the node j; M(pᵢ) denotes a set of nodes connected to node i; w(pᵢ, pⱼ) denotes the weight; PR(pⱼ; t) denotes the risk correlation value (or the risk correlation value to be updated) of the node j at the time t, the node j may be connected with the node i; PR(pᵢ; t+1) denotes the risk correlation value (or the risk correlation value to be updated) of the node i at the time t+1; and the second part of the formula (4) denotes the weighted sum of the risk correlation values of all lenders connected with the loan object.

In some embodiments, the weight involved in the above formula (4) may be determined based on the edge features (such as the similarity of the income and expenditure information, the working unit similarity, and the industry similarity) of the connected edges. In some embodiments, the similarity of the income and expenditure information, the working unit similarity, and the industry similarity may be positively related to the weight. In addition, the influences of the similarity of the income and expenditure information and the working unit similarity should be greater than that of the industry similarity. For example, assuming that the similarity of the income and expenditure information, the working unit similarity, and the industry similarity are a, b, c in order, then the weight may be calculated through the following formula (5):

w(pᵢ, pⱼ)=α*k₁+b*k₂+c*k₃ (5),

where k₁, k₂, k₃ may be preset weight coefficients, which satisfies k₁>k₂>k₃>0.

In some embodiments, the above weight may not be limited to the calculation modes mentioned in some embodiments of the present disclosure, but may further be calculated in any reasonable way, for example, the weight may be obtained by a weight model constructed by the related information of the loan object and the lender through a neural network.

In some embodiments, the preset damping coefficient d, the preset weight coefficients k₁, k₂, k₃ may be default values, experience values, manual preset values, etc. or any combination thereof, which may be set according to actual needs. The present disclosure does not limit it.

Some embodiments of the present disclosure determine the weight according to the actual influence of the income and expenditure situation on the risk correlation value, which may improve the accuracy of determining the risk correlation value.

In some embodiments, during the iteratively updating of the risk correlation value, the iteration ends when the iteration meets a preset iteration ending condition. The preset iteration ending condition may be a function convergence, or the count of iterations reaches a threshold. In some embodiments, the preset iteration ending condition may be that the sum of an absolute value of the difference between the risk correlation values of all nodes at two adjacent time is less than the preset threshold, and the preset condition may be represented by the following formula (6):

Σₚ_{ᵢ}_{∈G}|PR(pᵢ; t+1)−PR(pᵢ; t)<ε (6),

where G denotes the set of all nodes, and ε denotes the preset threshold.

The following is an example of the process of determining the risk correlation value through a plurality of iterations.

Operation 1: At the initial time (t=0), the risk correlation value of each node may be initialized. One optional mode is determining an initial risk correlation value before the iteration starts based on the above formula (3) and the total count of nodes in the knowledge map.

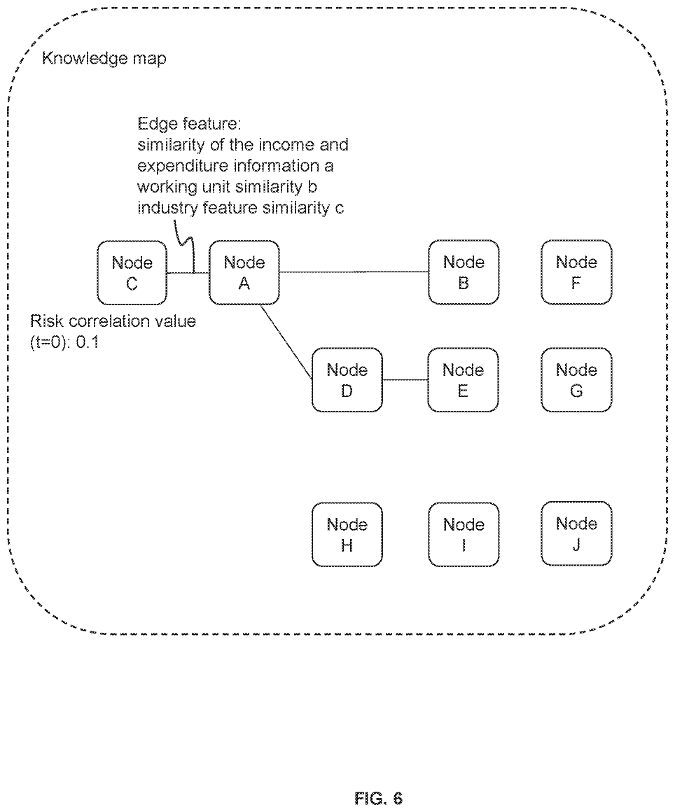

Exemplarily, as shown in FIG. 6, there are 10 nodes in the knowledge map (i.e., nodes A, B, C, D, E, F, G, H, I, J), then N=10, correspondently, the initial risk correlation value of each node may be 0.1 according to the aforementioned formula (3). Next, the weight coefficients respectively corresponding to the damping coefficient d and the similarity of the income and expenditure information a, the working unit similarity a, and the industry feature similarity may be set as k₁, k₂, k₃ , for example, for example, d=0.2, k₁=0.5, k₂=0.3, k₃₌0.2.

Operation 2: In each of the subsequent iterations, the corresponding weight of each node may be calculated based on the aforementioned formula (5), and the risk correlation value of each node may be calculated based on the aforementioned formula (4).

Exemplarily, as shown in FIG. 6, the iteration update of the risk correlation value is illustrated below by taking the second iteration process corresponding to calculating the risk correlation value of node A when t=1 as the example.

First, the similarities of the income and expenditure information a of nodes B, C, and D directly connected to node A, the working units similarity b, and the industry feature similarities c, and their corresponding weight coefficients k₁=0.5, k₂=0.3, k₃=0.2 may be put into the formula (5) to determine the weight w(pᵢ, pⱼ). For example, the weight of the edge A-B (i.e., the edge between the node A and the node B) may be: w(p_{A}, p_{B})=a₁*k₁+b₁*k₂+c₁*k₃, where a₁, b₁, c₁ are respectively corresponding to the similarity of the income and expenditure information of the edge A-B, the working units similarity of the edge A-B, and the industry feature similarity of the edge A-B. The weight of the edge A-C may be: w(p_{A}, p_{C})=a₂*k₁+b₂*k₂+c₂*k₃, where a₂, b₂, c₂ are respectively corresponding to the similarity of the income and expenditure information of the edge A-C, the working units similarity of the edge A-C, and the industry feature similarity of the edge A-C. The weight of the edge A-D may be: w(p_{A}, p_{D})=a₃*k₁+b₃*k₂+c₃*k₃, where a₃, b₃, c₃ are respectively corresponding to the similarity of the income and expenditure information of the edge A-D, the working units similarity of the edge A-D, and the industry feature similarity of the edge A-D.

Then, the total count of nodes of the knowledge map N and the preset damping coefficient d may be put into the formula (4), which may determine the first part of the formula (4). For example, when N=10, d=0.2, the first part of the formula (4) may be determined as 0.08.

Further, the risk correlation value to be updated PR(pⱼ;t), degree degree(pⱼ), weight w(pᵢ, pⱼ), and damping coefficient d of each node obtained after the previous iteration may be put into the formula (4), and the second part of the formula (4) may be determined.

Exemplarily, when determining the degree degree(pⱼ) of the node j, j may be the node A, whose degree degree(p_{A}) may be 3; j may be the node B, whose degree degree(p_{B}) may be 1; j may be C, whose degree degree(p_{C}) may be 1; and j may be D, whose degree degree(p_{D}) may be 2.

As shown in FIG. 6, nodes B, C, and D are directly connected to node A, and the above related parameters may be put into formula (4), and the second part of the formula (4) may be determined as: {[(w(p_{A}, p_{B})×0.08)÷degree(p_{B})]+[(w(p_{A}, p_{C})×0.08)+degree(p_{C})]+[(w(p_{A}, p_{D})×0.08)÷degree(p_{D})]}×0.2. Therefore, based on the aforementioned formula (4), the risk correlation value to be updated determined by node A in the first iteration may be determined.

Operation 3: subsequent iterations in turn (t=2, t=3, . . . ) are performed until the result meets the preset iteration end conditions, and the iteration ends. For example, the preset threshold may be 0.2. When t=10, the total count of nodes may be 10, and the risk correlation value of each node may be 0.4; when=11, the risk correlation value of each node may be 0.41, then a sum of the absolute value of the difference between the risk correlation values of all the nodes may be 0.1, which is less than the preset threshold 0.2. Correspondingly, the iteration may end, and the system may take the risk correlation value of each node determined when t=11 as the final risk correlation value of each node.

Some embodiments of the present disclosure may accurately determine the degree of mutual influence of other lenders on the loan object through determining the risk correlation value by iterations.

Some embodiments of the present disclosure may combine the neighborhood relationship and the risk correlation value, which gives full consideration on the relationship between the income and expenditure situation and the loan risk of each lender, thereby determining the related person more accurately.

Some embodiments of the present disclosure may determine the related person of the loan object from a plurality of lenders through the knowledge map, which provides a more intuitive and effective reference for assessing the loan risk of the loan object, thereby ensuring the safety of loans.

In some embodiments, the government management platform 230 may process basic information 710, first loan information 720, and second loan information 730 based on a prediction model 760 to determine a loan risk 770 of a loan object. The second loan information includes the loan information of at least one related person. It should be noted that when determining the loan risk of the loan object, the main factor considered is the basic information of the loan object and the first loan information of the loan object, and the second loan information of the related person may be used as an auxiliary factor to be considered. Correspondingly, when the basic information, the first loan information, and the second loan information are input to the prediction model, different input weights may be given to each input variable. For example, the basic information of the loan object and the first loan information of the loan object may be given a great input weight, and the second loan information of the related person may be given a smaller input weight.

The prediction model 760 may be used to predict the loan risk of the loan object. In some embodiments, the prediction model 760 may be a recurrent neural network (RNN).

In some embodiments, the input of the prediction model 760 may be the basic information 710, the first loan information 720, and the second loan information 730, and the output of the prediction model 760 may be the loan risk 770 of the loan object.

The parameters of the prediction model may be obtained through training. In some embodiments, the prediction model may be trained through a plurality of training samples with labels. For example, a plurality of training samples with labels may be input into an initial prediction model, and a loss function may be constructed through the labels and the results of the initial prediction model, and the parameters of the prediction model may be iteratively updated based on the loss function. The model training may be completed when the loss function of the initial prediction model meets the preset condition, and a trained model may be obtained. The preset condition may be the convergence of the loss function, or the count of iterations reaching a threshold, etc.

In some embodiments, the training sample may include sample basic information of a sample loan object, sample first loan information, and sample second loan information of the sample loan object. The label may be a loan risk of the sample loan object. In some embodiments, the training sample may be obtained based on historical information (for example, historical basic information, historical first loan information, and historical second loan information), and the label may be obtained through manual labeling.

It is understandable that the second loan information may include loan information corresponding to a plurality of related persons. In some embodiments, before inputting the second loan information to the prediction model, the second loan information may be processed, that is, the corresponding risk features of each related person may be determined.

In some embodiments, the government management platform 230 may process the second loan information 730 based on the feature model 740 to determine at least one risk feature 742. Correspondingly, the input of the prediction model 760 may be the basic information 710, the first loan information 720, and at least one risk feature 742.

It is worth noting that the second loan information contains a large amount of privacy data of the related person. Considering the data security of the financial service platform, when the feature model 740 processes the second loan information 730, the government management platform 230 may perform a multi-party secure calculating processing on the second loan information 720. The processed risk features 742 may reflect the second loan information 720 of the related person through the encrypted data without involving the specific data of the related person and exposing the privacy information of the related person. The multi-party secure calculating processing may ensure that the information input by members of all parts participating in the calculation may not be exposed on the premise of no reliable third party and may obtain an accurate result.

The risk feature may refer to a feature vector used to represent the second loan information of a candidate related person. For example, basic information, historical repaying information, and other credit information, etc. in the second loan information may be spliced and used as the risk features. In some embodiments, each related person corresponds to a risk feature.

The feature model may be used to determine the risk feature corresponding to the second loan information of the related person. In some embodiments, the feature model may be a convolutional neural network (CNN). In some embodiments, the input of the feature model 740 may be the second loan information 730, and the output of the feature model 740 may be at least one risk feature 742.

In some embodiments, when there is a plurality of risk features, the feature model may further fuse the plurality of risk features to determine a fusion feature used to represent the plurality of risk features. In some embodiments, the feature model may fuse the at least one risk feature based on a fusion weight to determine the fusion features. The fusion features may be the risk correlation value corresponding to each related person. Correspondingly, the fusion features may be used as the input of the prediction model. Correspondingly, the input of the feature model 740 may be the second loan information 730, and the output of the feature model 740 may be the fusion feature 750.

In some embodiments, correspondingly, the feature model 740 may include a feature extraction layer 741 and a fusion layer 744. The feature extraction layer 741 may be configured to process the second loan information 730 to determine at least one risk feature 742. In some embodiments, the input of the feature extraction layer 741 may be the second loan information 730, and the output of the feature extraction layer 741 may be the at least one risk feature 742. In some embodiments, a model type of the feature extraction layer may be CNN. The fusion layer 744 may be used to fuse the at least one risk feature 742 based on the fusion weight 743 to determine the fusion feature 750. In the fusion process, the fusion weight 743 corresponding to each risk feature 742 may be the risk correlation value of the corresponding node of each related person. Correspondingly, the fusion layer 744 may perform fusion process on the risk features 742 of each related person and the risk correlation value corresponding to each related person. In some embodiments, the input of the fusion layer 744 may include at least one risk feature 742 and the corresponding fusion weight 743, and the output of the fusion layer 744 may be the fusion feature 750. In some embodiments, the model type of the fusion layer may be DNN.

It may be understood that after the feature model 740 performs fusion process on the plurality of risk features 742, the input of the predicted model 760 may include the basic information 710, the first loan information 720, and the fusion feature 750.

In some embodiments of the present disclosure, through the fusion features, the influence of each related person on the loan object may be represented. Meanwhile, through the fusion weight of each related person, the risk feature of each related person may be fused to determine the fusion features, and further, the loan risk of the loan object may be determined accurately and efficiently.

The parameters of the feature model may be obtained through a joint training. In some embodiments, two initial feature sub-models sharing parameters and a similarity model may be configured for the joint training. Then, one of the two trained feature sub-models sharing parameters may be determined as a trained feature model. It should be noted that the feature model and the feature sub-model only have differences in the name. An exemplary training process may be as follows.

The two different training samples may be input to two feature sub-models to obtain two fusion features output by two feature sub-models; then the two fusion features may be taken as the input of the similarity model to obtain a similarity result of the similarity model. Further, based on the similarity result output by the similarity model as well as the label, the loss function may be constructed, based on the loss function, the parameters of the two initial feature sub-models may be iteratively updated at the same time until the training meets the preset condition. Then one of the trained feature sub-models may be determined as the trained feature model. The preset condition may be that the loss function is less than the threshold or converges, or a training period reaches a threshold.

In some embodiments, each group of training samples may include the sample second loan information of a sample related person, or may also include the sample second loan information of a plurality of sample related persons. Exemplarily, for the situation where each group of training samples includes the sample second loan information of a sample related person, the second loan information corresponding to the sample related person A may be input in a feature sub-model, and second loan information corresponding to the sample related person B may be input into another feature sub-model. For the situation where each group of training samples includes the sample second loan information of a plurality of sample related persons, the second loan information corresponding to the sample related persons A, B, and C may be input to one feature sub-model, and the second loan information corresponding to the sample related persons D, E and F may be input to another feature sub-model.

In some embodiments, the label corresponding to the training sample may be the similarity of historical repaying information in the sample second loan information corresponding to the sample related person. For example, the label may be the similarity of a count of overdues and the count of days of overdue in the second loan information corresponding to the sample related person. In some embodiments, the label may be determined by calculating the vector distance of the corresponding vector of the historical repaying information.

In some cases, the parameters of the feature model obtained through the above training modes may facilitate to solve the problem that it is difficult to obtain the labels when training feature models individually. Besides that, it may further make the feature model better reflect the fusion feature of a plurality of second loan information.

In some embodiments of the present disclosure, the second loan information may be processed through the feature model to determine a plurality of risk features, so that the performance of the second loan information may be more intuitive, and it may be more convenient to represent the loan risks of a plurality of loan objects. Furthermore, when the basic information and loan information is analyzed through the prediction model, financial institutions (such as banks) may timely and accurately obtain the loan risks of the loan objects.

It may be understood that to predict future information based on the historical data, for example, to predict future weather information according to historical weather information, and to predict production data of a future assembly line according to the production data of a historical assembly line, etc. For a prediction result of a prediction object, the prediction result may not be perfectly accurate. However, when a model is used to predict a large amount of predicted objects, such as predicting 10,000 predicted objects, 100,000 predicted objects, . . . , etc., the obtained prediction results may meet the accuracy requirement of the model through the improvement of the model, for example, the accuracy may be 95%, 98%, . . . , and so on. The accuracy requirements set by different models may be different. The prediction ability of big data should not be questioned because of individual prediction results. Obviously, predictions based on big data are in line with natural laws.

It should be noted that the above descriptions related to flowcharts are only for the purpose of illustration, and not intended to limit the scope of the present disclosure. For those skilled in the art, various modifications and changes may be made to the flows under the guidance of the present disclosure. However, these changes and modifications are still within the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, which are within the spirit and range of the exemplary embodiments of this disclosure.

Furthermore, the recited order of processing elements or sequences, or the use of counts, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and range of the disclosed embodiments. For example, although the implementation of various assemblies described above may be embodied in a hardware device, it may also be implemented as a software only solution, for example, an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the counts expressing quantities or properties used to describe and claim certain embodiments of the application are to be understood as being modified in some instances by the term “about,” “approximate,” or “substantially.” For example, “about,” “approximate,” or “substantially” may indicate a ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the count of reported significant digits and by applying ordinary rounding techniques. Notwithstanding that the numerical ranges and parameters setting forth the broad range of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest range of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the range of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method for loan risk assessment in a smart city based on an Internet of Things (IoT), wherein the method may be performed by a government management platform, comprising:
obtaining a risk query request from a financial service platform, wherein the risk query request is generated in response to a loan request input by a loan object on a user platform;
determining a related person of the loan object, wherein an income and expenditure situation of the related person is similar to that of the loan object;
in response to the risk query request,
determining, based on a population information platform, basic information of the loan object, wherein the basic information at least includes income and expenditure information;
obtaining, based on the financial service platform, a first loan information of the loan object and a second loan information of the related person;
determining, based on the basic information, the first loan information, and the second loan information, a loan risk of the loan object; and
sending the loan risk to the financial service platform.

2. The method of claim 1, wherein the determining the related person of the loan object comprises:
determining at least one candidate related person of the loan object from the population information platform;
determining a first income and expenditure situation of the loan object and a second income and expenditure situation of the at least one candidate related person; and
determining, based on a similarity of the first income and expenditure situation and the second income and expenditure situation, the related person of the loan object.

3. The method of claim 1, wherein the determining the related person of the loan object further comprises:
constructing, based on relevant information of the loan object and relevant information of each lender in the financial service platform, a knowledge map;
taking the loan object and each lender as nodes of the knowledge map, wherein a node feature is the first loan information of the loan object or loan information corresponding to the lender;
constructing edges of the knowledge map according to a similarity of the income and expenditure information between the loan object and each lender, wherein an edge feature is the similarity of the income and expenditure information; and
determining, based on a neighbourhood relationship, the related person of the loan object.

4. The method of claim 3, wherein the edge feature further include at least one of a working unit similarity and an industry feature similarity.

5. The method of claim 3, wherein
the node features further include a risk correlation value; and
the determining the related person of the loan object further comprises:
determining, based on the neighbourhood relationship and the risk correlation value, the related person of the loan object.

6. The method of claim 5, wherein the risk correlation value is obtained through multiple iterative updates;
in the first iteration, for each node, a risk correlation value to be updated in the next iteration is determined based on a total count of nodes, a count of connected nodes, and a risk correlation value to be updated of the connected nodes in the first iteration, wherein the risk correlation value to be updated in the first iteration is determined according to a total count of nodes of the knowledge map; and
in each of the subsequent iterations, for each node, the risk correlation value to be updated in the next iteration is determined based on the total count of nodes, the count of connected nodes, and the risk correlation value to be updated of the connected nodes in the current iteration.

7. The method of claim 1, wherein the determining, based on the basic information, the first loan information, and the second loan information, a loan risk of the loan object comprises:
determining the loan risk of the loan object through processing, based on a prediction model, the basic information, the first loan information, and the second loan information.

8. The method of claim 7, further comprising:
determining at least one risk feature through processing, based on a feature model, the second loan information.

9. The method of claim 8, further comprising:
determining a fusion feature through fusing, based on a fusion weight, the at least one risk feature, wherein the fusion weight is the risk correlation value corresponding to each of the related person; and
taking the fusion feature as an input of the prediction model.

10. A system for loan risk assessment in a smart city based on an Internet of Things (IoT), wherein the system at least includes a user platform, a service platform, and a government management platform, wherein
the user platform is configured to interact with a user;
the service platform is configured to receive and transmit information;
the government management platform is configured to perform operations including:
obtaining a risk query request from a financial service platform, wherein the risk query request is generated in response to a loan request input by a loan object on the user platform;
determining a related person of the loan object, wherein an income and expenditure situation of the related person is similar to that of the loan object;
in response to the risk query request,
determining, based on a population information platform, basic information of the loan object, wherein the basic information at least includes income and expenditure information;
obtaining, based on the financial service platform, a first loan information of the loan object and a second loan information of the related person;
determining, based on the basic information, the first loan information, and the second loan information, a loan risk of the loan object; and
sending the loan risk to the financial service platform.

11. The system of claim 10, wherein to determine the related person of the loan object, the government management platform is further configured to:
determine at least one candidate related person of the loan object from the population information platform;
determine a first income and expenditure situation of the loan object and a second income and expenditure situation of the at least one candidate related person; and
determine, based on a similarity of the first income and expenditure situation and the second income and expenditure situation, the related person of the loan object.

12. The system of claim 10, wherein to determine the related person of the loan object, the government management platform is further configured to:
construct, based on relevant information of the loan object and relevant information of each lender in the financial service platform, a knowledge map;
take the loan object and each lender as nodes of the knowledge map, wherein a node feature is the first loan information of the loan object or loan information corresponding to the lender;
construct edges of the knowledge map according to a similarity of the income and expenditure information between the loan object and each lender, wherein an edge feature is the similarity of the income and expenditure information; and
determine, based on a neighbourhood relationship, the related person of the loan object.

13. The system of claim 12, wherein the edge feature further includes at least one of a working unit similarity and an industry feature similarity.

14. The system according to claim 12, wherein
the node feature further includes a risk correlation value; and
to determine the related person of the loan object, the government management platform is further configured to:
determine, based on the neighbourhood relationship and the risk correlation value, the related person of the loan object.

15. The system of claim 14, the risk correlation value is obtained through multiple iterative updates;
in the first iteration, for each node, a risk correlation value to be updated in next iteration is determined based on a total count of nodes, a count of connected nodes, and a risk correlation value to be updated of the connected nodes in the first iteration, wherein the risk correlation value to be updated in the first iteration is determined according to a total count of nodes of the knowledge map; and
in each of the subsequent iterations, for each node, the risk correlation value to be updated in the next iteration is determined based on the total count of nodes, the count of connected nodes, and the risk correlation value to be updated of the connected nodes in the current iteration.

16. The system of claim 10, wherein to determine the loan risk of the loan object based on the basic information, the first loan information, and the second loan information, the government management platform is further configured to:
determine the loan risk of the loan object through processing, based on a prediction model, the basic information, the first loan information, and the second loan information.

17. The system of claim 16, wherein the government management platform is further configured to:
determine at least one risk feature through processing, based on a feature model, the second loan information.

18. The system of claim 17, wherein the government management platform is further configured to:
determine a fusion feature through fusing, based on a fusion weight, the at least one risk feature, wherein the fusion weight is the risk correlation value corresponding to each of the related person; and
take the fusion feature as an input of the prediction model.

19. A non-transitory computer-readable storage medium storing computer instructions, wherein when reading the computer instructions in the storage medium, a computer implements the method for loan risk assessment in a smart city based on an Internet of Things (IoT) according to claim 1.
